(19) United States
(12) Patent Application Publication
(10) Pub. No.: US 2023/0408724 A1
(43) Pub. Date: Dec. 21, 2023

(54) Methods and Systems for Hydrocarbon Future Field Size Assessment

(71) Applicant: Saudi Arabian Oil Company, Dhahran (SA)

(72) Inventor: Fahad Najrani, Dhahran (SA)

(21) Appl. No.: 17/844,997

(22) Filed: Jun. 21, 2022

(51) Int. Cl. G01V 99/00; G06F 30/13

(52) U.S. Cl. CPC G01V 99/005; G06F 30/13; G06F 2111/02

(57) ABSTRACT

Processes for determining a hydrocarbon future field size distribution (FFSD) of a geologic area of interest such as a basin. The process includes dividing discovered volumes from the area of interest into sorted quintiles, graphing sorted prospect volumes from prospect scenarios for the area of interest with a selected quintile, and classifying the prospect scenarios based on a comparison with the selected quintile of discovered volumes. A prospect scenario may be selected based on the classification, and the prospect volumes of the selected scenario are combined with the discovered volumes from the selected quintile to create a future field size distribution (FFSD) for the area of interest. Computer-readable media and systems for determining a hydrocarbon future field size distribution (FFSD) of a geologic area of interest are also provided.

### BACKGROUND

### Field of the Disclosure

The present disclosure generally relates to hydrocarbon exploration. More specifically, embodiments of the disclosure relate to assessing undiscovered hydrocarbon resources in areas of exploration interest.

### Description of the Related Art

The proactive exploration and securement of future hydrocarbon resources (for example, oil and gas) is of strategic importance to petroleum and gas companies as well as sovereign states. However, the exploration and discovery of new hydrocarbon producing locations may be challenging due to different geological environments and conditions. Additionally, the exploration and subsequent production of hydrocarbons may involve very large financial and time commitments. Hydrocarbon exploration activities in a given geologic area of interest are mainly controlled by the size of opportunities or prospects.

The geological environments and conditions, financial commitments, time commitments, and other factors involved increase the difficulty in evaluating and classifying hydrocarbon resources in potential prospective areas. Moreover, the development and accuracy of long-term corporate strategies may depend heavily on the evaluation and classification of hydrocarbon resources in such areas.

### SUMMARY

Hydrocarbon resource assessment of undiscovered hydrocarbon resource potential may be performed using geologic risk, the number of undrilled prospects, and future field size distribution (FFSD). Embodiments of the disclosure generally relate to methods, systems, and computer-readable media for determining a hydrocarbon future field size distribution (FFSD) of a geologic area of interest.

In one embodiment, a method for determining a future field size distribution of a geologic area of interest is provided. The method includes obtaining a plurality of discovered volumes associated with the geologic area of interest, the plurality of discovered volumes associated with a respective plurality of dates, and sorting the plurality of discovered volumes by the respective plurality of dates. The method also includes dividing the sorted plurality of discovered volumes into quintiles, such that each quintile includes a sorted subset of the plurality of discovered volumes and each quintile is sorted by a size of the respective subset of the plurality of discovered volumes. The method further includes assigning a probability to each discovered volume of the respective subset of the plurality of discovered volumes of each quintile and obtaining a plurality of prospect scenarios associated with the geologic area of interest, such that the plurality of prospect scenarios is associated with a sorted respective plurality of prospect volumes and each of the plurality of prospect scenarios is sorted by a size of the respective plurality of prospect volumes. Additionally, the method includes assigning a probability to each of the prospect volume of the sorted respectively plurality of prospect volumes of each of the plurality of prospect scenarios, plotting, on a lognormal scale versus probability, the sorted subset of the plurality of discovered volumes of a selected quintile and the sorted respective plurality of prospect volumes for each of the plurality of prospect scenarios, and classifying the plurality of prospect scenarios into a first class, a second class, or a third class based on a comparison with the sorted subset of the plurality of discovered volumes. The method also includes selecting, based on the classification, a prospect scenario of the plurality of prospect scenarios and determining the future field size distribution (FFSD) for the geologic area of interest by combining the sorted respective plurality of prospect volumes of the selected prospect scenario with the sorted subset of the plurality of discovered volumes of the selected quintile.

In some embodiments, the method includes classifying the determined future field size distribution (FFSD) based on the classification of the selected prospect scenario. In some embodiments, determining the future field size distribution (FFSD) for the geologic area of interest includes determining the future field size distribution (FFSD) for an undiscovered hydrocarbon resource assessment. In some embodiments, the method includes selecting a drilling target or location in the area of interest based on the determined future field size distribution (FFSD). In some embodiments, the method includes drilling a well at the selected drilling location in the area of interest. In some embodiments, classifying the plurality of prospect scenarios into a first class, a second class, or a third class based on a comparison with the graphed subset of the plurality of discovered volumes includes classifying one of plurality of prospect scenarios into the first class if the respective plurality of prospect volumes is less than or equal to 20% of the graphed subset of the plurality of discovered volumes. In some embodiments, assigning a probability to each discovered volume of each quintile includes calculating a probability of the first discovered volume of a quintile as (100/n+1)/100, where n is the number of volumes in the quintile and calculating a probability of each additional discovered volume of the quintile as i*(100/n+1)/100, where i is the number of the additional discovered volume. In some embodiments, determining the future field size distribution (FFSD) for the geologic area of interest by combining the selected prospect scenario with the subset of the plurality of discovered volumes of the selected quintile includes combining the sorted respective plurality of prospect volumes of the selected prospect scenario with the sorted subset of the plurality of discovered volumes of the selected quintile to create a plurality of merged volumes, sorting the plurality of merged volumes from largest to smallest, assigning a probability to each volume of the plurality of merged volumes, and plotting, in lognormal values, the sorted plurality of merged volumes versus assigned probability. In some embodiments, assigning a probability to each discovered volume of each quintile includes calculating a probability of the first discovered volume of a quintile as (100/n+1)/100, where n is the number of volumes in the group and calculating a probability of each additional discovered volume of the quintile as i*(100/n+1)/100, where i is the number of the additional discovered volume.

In another embodiment, a non-transitory computer-readable storage medium having executable code stored thereon for hydrocarbon resource exploration assessment is provided. The executable code has a set of instructions that causes a processor to perform operations that include obtaining a plurality of discovered volumes associated with the geologic area of interest, the plurality of discovered volumes associated with a respective plurality of dates, and sorting the plurality of discovered volumes by the respective plurality of dates. The operations also include dividing the sorted plurality of discovered volumes into quintiles, such that each quintile includes a sorted subset of the plurality of discovered volumes and each quintile is sorted by a size of the respective subset of the plurality of discovered volumes. The operations further include assigning a probability to each discovered volume of the respective subset of the plurality of discovered volumes of each quintile and obtaining a plurality of prospect scenarios associated with the geologic area of interest, such that the plurality of prospect scenarios is associated with a sorted respective plurality of prospect volumes and each of the plurality of prospect scenarios is sorted by a size of the respective plurality of prospect volumes. Additionally, the operations include assigning a probability to each of the prospect volume of the sorted respectively plurality of prospect volumes of each of the plurality of prospect scenarios, plotting, on a lognormal scale versus probability, the sorted subset of the plurality of discovered volumes of a selected quintile and the sorted respective plurality of prospect volumes for each of the plurality of prospect scenarios, and classifying the plurality of prospect scenarios into a first class, a second class, or a third class based on a comparison with the sorted subset of the plurality of discovered volumes. The operations also include selecting, based on the classification, a prospect scenario of the plurality of prospect scenarios and determining the future field size distribution (FFSD) for the geologic area of interest by combining the sorted respective plurality of prospect volumes of the selected prospect scenario with the sorted subset of the plurality of discovered volumes of the selected quintile.

In some embodiments, the operations include classifying the determined future field size distribution (FFSD) based on the classification of the selected prospect scenario. In some embodiments, the method includes selecting a drilling target or location in the area of interest based on the determined future field size distribution (FFSD). In some embodiments, classifying the plurality of prospect scenarios into a first class, a second class, or a third class based on a comparison with the graphed subset of the plurality of discovered volumes includes classifying one of plurality of prospect scenarios into the first class if the respective plurality of prospect volumes is less than or equal to 20% of the graphed subset of the plurality of discovered volumes. In some embodiments, assigning a probability to each discovered volume of each quintile includes calculating a probability of the first discovered volume of a quintile as (100/n+1)/100, where n is the number of volumes in the quintile and calculating a probability of each additional discovered volume of the quintile as i*(100/n+1)/100, where i is the number of the additional discovered volume. In some embodiments, determining the future field size distribution (FFSD) for the geologic area of interest by combining the selected prospect scenario with the subset of the plurality of discovered volumes of the selected quintile includes combining the sorted respective plurality of prospect volumes of the selected prospect scenario with the sorted subset of the plurality of discovered volumes of the selected quintile to create a plurality of merged volumes, sorting the plurality of merged volumes from largest to smallest, assigning a probability to each volume of the plurality of merged volumes, and plotting, in lognormal values, the sorted plurality of merged volumes versus assigned probability.

In another embodiment, a system for hydrocarbon resource exploration assessment is provided. The system includes a processor and a non-transitory computer-readable storage memory accessible by the processor and having executable code stored thereon. The executable code has a set of instructions that causes a processor to perform operations that include obtaining a plurality of discovered volumes associated with the geologic area of interest, the plurality of discovered volumes associated with a respective plurality of dates, and sorting the plurality of discovered volumes by the respective plurality of dates. The operations also include dividing the sorted plurality of discovered volumes into quintiles, such that each quintile includes a sorted subset of the plurality of discovered volumes and each quintile is sorted by a size of the respective subset of the plurality of discovered volumes. The operations further include assigning a probability to each discovered volume of the respective subset of the plurality of discovered volumes of each quintile and obtaining a plurality of prospect scenarios associated with the geologic area of interest, such that the plurality of prospect scenarios is associated with a sorted respective plurality of prospect volumes and each of the plurality of prospect scenarios is sorted by a size of the respective plurality of prospect volumes. Additionally, the operations include assigning a probability to each of the prospect volume of the sorted respectively plurality of prospect volumes of each of the plurality of prospect scenarios, plotting, on a lognormal scale versus probability, the sorted subset of the plurality of discovered volumes of a selected quintile and the sorted respective plurality of prospect volumes for each of the plurality of prospect scenarios, and classifying the plurality of prospect scenarios into a first class, a second class, or a third class based on a comparison with the sorted subset of the plurality of discovered volumes. The operations also include selecting, based on the classification, a prospect scenario of the plurality of prospect scenarios and determining the future field size distribution (FFSD) for the geologic area of interest by combining the sorted respective plurality of prospect volumes of the selected prospect scenario with the sorted subset of the plurality of discovered volumes of the selected quintile.

In some embodiments, the operations include classifying the determined future field size distribution (FFSD) based on the classification of the selected prospect scenario. In some embodiments, the method includes selecting a drilling target or location in the area of interest based on the determined future field size distribution (FFSD). In some embodiments, classifying the plurality of prospect scenarios into a first class, a second class, or a third class based on a comparison with the graphed subset of the plurality of discovered volumes includes classifying one of plurality of prospect scenarios into the first class if the respective plurality of prospect volumes is less than or equal to 20% of the graphed subset of the plurality of discovered volumes. In some embodiments, assigning a probability to each discovered volume of each quintile includes calculating a probability of the first discovered volume of a quintile as (100/n+1)/100, where n is the number of volumes in the quintile and calculating a probability of each additional discovered volume of the quintile as i*(100/n+1)/100, where i is the number of the additional discovered volume. In some embodiments, determining the future field size distribution (FFSD) for the geologic area of interest by combining the selected prospect scenario with the subset of the plurality of discovered volumes of the selected quintile includes combining the sorted respective plurality of prospect volumes of the selected prospect scenario with the sorted subset of the plurality of discovered volumes of the selected quintile to create a plurality of merged volumes, sorting the plurality of merged volumes from largest to smallest, assigning a probability to each volume of the plurality of merged volumes, and plotting, in lognormal values, the sorted plurality of merged volumes versus assigned probability.

### BRIEF DESCRIPTION OF THE DRAWINGS

FIG. 1 is a block diagram of a process for determining a hydrocarbon future field size distribution (FFSD) of a geologic area of interest in accordance with an embodiment of the present disclosure;

FIG. 2 is a plot of discovered volumes in lognormal scale vs. probability in accordance with an embodiment of the disclosure;

FIG. 3 is a plot of discovered volumes and prospect volumes in lognormal scale vs. probability in accordance with an embodiment of the disclosure;

FIG. 4 is a plot of volumes in lognormal scale vs. probability comparing the example prospect scenarios with a discovered volume quintile in accordance with an embodiment of the disclosure;

FIG. 5 is a plot of determined future field size distribution (FFSD) volumes in lognormal scale in accordance with an embodiment of the disclosure; and

FIG. 6 is a block diagram of components of a future field size distribution (FFSD) assessment computer in accordance with an embodiment of the disclosure.

### DETAILED DESCRIPTION

The present disclosure will now be described more fully hereinafter with reference to the accompanying drawings, which illustrate embodiments of the disclosure. This disclosure may, however, be embodied in many different forms and should not be construed as limited to the illustrated embodiments set forth herein. Rather, these embodiments are provided so that this disclosure will be thorough and complete, and will fully convey the scope of the disclosure to those skilled in the art.

Methods, systems, and computer-readable media are provided for determining a hydrocarbon future field size distribution (FFSD) of a geologic area of interest (e.g., a geologic basin). As described in the disclosure, a process for determining a hydrocarbon future field size distribution (FFSD) may include sorting discovered volumes associated with the geologic area of interest and dividing the discovered volumes into quintiles. Prospect volumes from prospect scenarios may be compared with a selected quintile of discovered volumes and classified based on the comparison. A prospect scenario may be selected based on the classification. A future field size distribution (FFSD) may then be determined by combining the discovered volumes of the selected quintile and the prospect volumes of the selected prospect scenario.

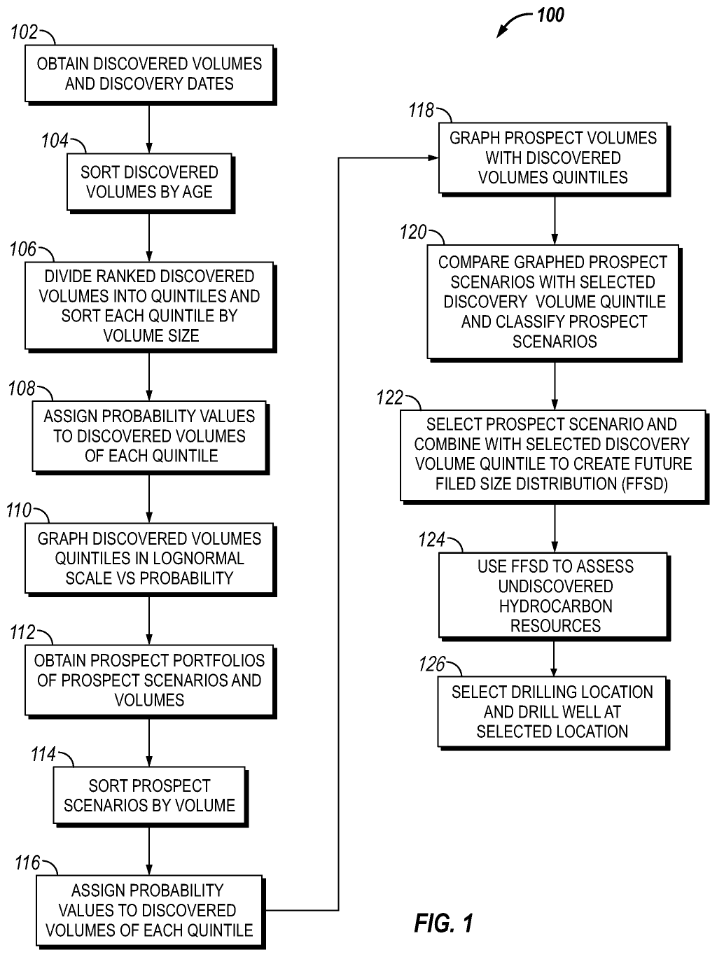

FIG. 1 depicts a process 100 for determining a hydrocarbon future field size distribution (FFSD) of a geologic area of interest in accordance with an embodiment of the present disclosure. Initially, discovered volumes and associated discovery dates may be obtained (block 102). For example, the discovery volumes may be a result of exploratory or discovery wells drilled in the geologic area of interest over a period of time. Discovered hydrocarbon volumes are assessed and recorded for the geologic area of interest. In some embodiments, the discovery volumes may include additional associated data. For example, in some embodiments a discovery volume may be associated with a field name, a reservoir name, a hydrocarbon type (e.g., oil, gas, and gas condensate), discovery date, volumes of each fluid type, and cumulative equivalent volume. In such embodiments, the discovery volume data information may be obtained in a tabulated format having each item of data. In some embodiments, the discovery volume information may be obtained from a database of discovery volume information for a given geologic area of interest, such as from determined from previous exploration wells in the geologic area.

Next, the discovered volumes may be sorted by age, such as from youngest to oldest (block 104). That is, the ranking may be performed using the dates associated with the discovered volumes. For example, the discovered volumes may be ranked from oldest to youngest. Tables 1-4 below illustrate a ranking of discovered volumes for an example of discovered volumes information. Each Table lists a Discovery Date (year) and an associated Volume (in millions barrels of oil equivalent (MMBOE):

TABLE 1
SORTED DISCOVERED VOLUMES

| | Disc. Date | | | | | | | | | | | |
|---|---|---|---|---|---|---|---|---|---|---|---|---|
| | 1950 | 1952 | 1954 | 1956 | 1958 | 1960 | 1962 | 1964 | 1965 | 1966 | 1967 | 1969 |
| Vol. | 875 | 219 | 109 | 438 | 1750 | 27 | 3500 | 14 | 55 | 306 | 19 | 38 |

TABLE 2
SORTED DISCOVERED VOLUMES CONT.

| | Disc. Date | | | | | | | | | | | |
|---|---|---|---|---|---|---|---|---|---|---|---|---|
| | 1971 | 1973 | 1975 | 1977 | 1979 | 1980 | 1981 | 1982 | 1984 | 1986 | 1988 | 1990 |
| Vol. | 1225 | 2450 | 10 | 153 | 77 | 613 | 1750 | 438 | 7 | 219 | 875 | 55 |

TABLE 3
SORTED DISCOVERED VOLUMES CONT.

| | Disc. Date | | | | | | | | | | | |
|---|---|---|---|---|---|---|---|---|---|---|---|---|
| | 1992 | 1994 | 1995 | 1996 | 1997 | 1999 | 2001 | 2003 | 2005 | 2007 | 2009 | 2010 |
| Vol. | 27 | 14 | 109 | 16 | 525 | 33 | 1050 | 66 | 4 | 263 | 8 | 131 |

TABLE 4
SORTED DISCOVERED VOLUMES CONT.

| | Disc. Date | | | | | | | | |
|---|---|---|---|---|---|---|---|---|---|
| | 2011 | 2011 | 2012 | 2013 | 2014 | 2015 | 2016 | 2017 | 2018 |
| Vol. | 8 | 4 | 16 | 263 | 525 | 33 | 66 | 131 | 2 |

After sorting the discovered volumes by date, the ranked discovered volumes may be divided into quintiles, and each quintile is sorted by volume from large to small (block 106). That is, the volumes in each quintile may be sorted by largest to smallest. For example, Table 5 depicts the discovered volumes from Tables 1-4 divided into quintiles and sorted by volume:

TABLE 5
SORTED DISCOVERED VOLUMES QUINTILES

| First | Second | Third | Fourth | Fifth |
|---|---|---|---|---|
| Quintile | Quintile | Quintile | Quintile | Quintile |
| 3500 | 2450 | 1050 | 1400 | 525 |
| 1750 | 1225 | 525 | 700 | 263 |
| 875 | 613 | 263 | 350 | 131 |
| 438 | 306 | 131 | 175 | 66 |
| 219 | 153 | 66 | 88 | 33 |
| 109 | 77 | 33 | 44 | 16 |
| 55 | 38 | 16 | 22 | 8 |
| 27 | 19 | 8 | 11 | 4 |
| 14 | 10 | 4 | 5 | 2 |

Next, probability values are assigned to each volume in each quintile (block 108). In some embodiments, the probability values may be calculated according to the following formula:

$$Probability value = \{ \begin{matrix}\frac{( \frac{100}{n + 1} )}{100} , & for i = 1 \\ ( \frac{( \frac{100}{n + 1} )}{100} ) * i , & for i > 1\end{matrix} \qquad ( 1 )$$

where n is the total number of volumes in a quintile and i is the number of the current volume in the quintile. Table 6 depicts the probabilities for the quintiles of Table 5:

TABLE 6
SORTED DISCOVERED VOLUMES
QUINTILES AND PROBABILITIES

| | | | | | Probability |
|---|---|---|---|---|---|
| First | Second | Third | Fourth | Fifth | of Each |
| Quintile | Quintile | Quintile | Quintile | Quintile | Volume |
| 3500 | 2450 | 1050 | 1400 | 525 | 0.9 |
| 1750 | 1225 | 525 | 700 | 263 | 0.8 |
| 875 | 613 | 263 | 350 | 131 | 0.7 |
| 438 | 306 | 131 | 175 | 66 | 0.6 |
| 219 | 153 | 66 | 88 | 33 | 0.5 |
| 109 | 77 | 33 | 44 | 16 | 0.4 |
| 55 | 38 | 16 | 22 | 8 | 0.3 |
| 27 | 19 | 8 | 11 | 4 | 0.2 |
| 14 | 10 | 4 | 5 | 2 | 0.1 |

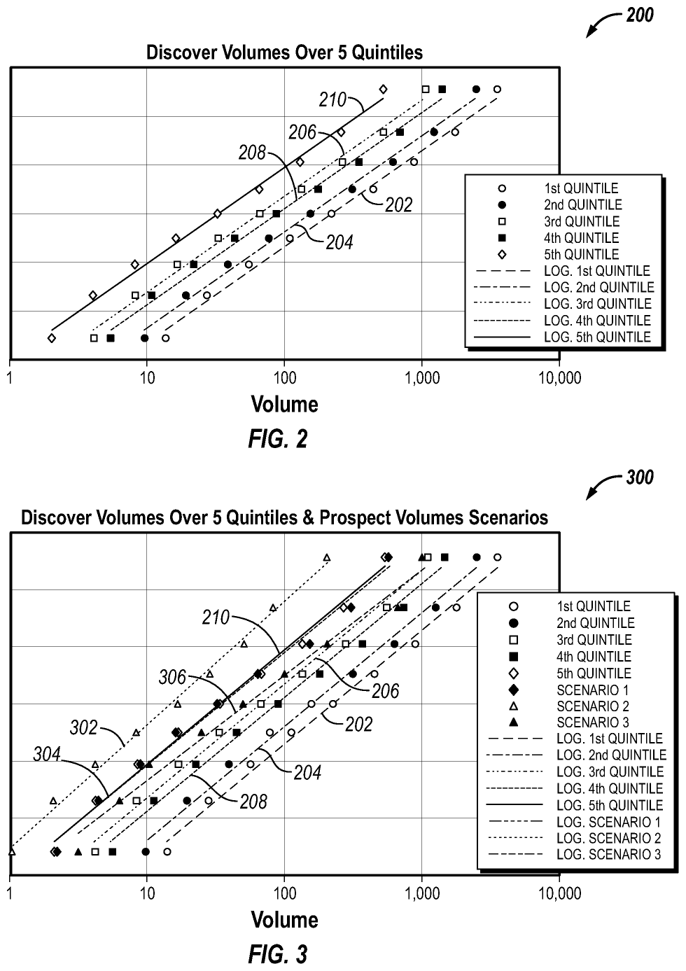

Next, the quintiles may be plotted in lognormal scale vs. probability (block 110). FIG. 2 depicts a plot 200 of discovered volumes (on the x-axis) in lognormal scale vs. probability (on the y-axis) in accordance with an embodiment of the disclosure. By way of example, FIG. 2 depicts the volumes of each quintile from Tables 5 and 6. In some embodiments, a line for each quintile may be fit to the respective volumes of the quintile further illustrate each quintile and evaluate the level of volume variation. As shown in FIG. 2, line 202 corresponds to the First Quintile of Table 5, line 204 corresponds to the Second Quintile of Table 5, line 206 corresponds to the Third Quintile of Table 5, line 208 corresponds to the Fourth Quintile of Table 5, and line 210 corresponds to the Fifth Quintile of Table 5.

As shown by each line in FIG. 2, larger volumes are initially discovered followed by smaller volumes as a basin or other geologic area is maturing in terms of exploration. The level of volume variation may be estimated for each quintile may be determined from the slope of the line associated with the quintile. A relatively steeper line may be observed with time as a basin or other geologic area is maturing.

Next, prospect portfolios associated with the geologic area of interest may be obtained (block 112). A prospect portfolio may include prospect scenarios and associated volumes. In some embodiments, the prospect scenarios may include additional associated data. For example, in some embodiments a prospect scenario may be associated with a targeted reservoir name, a hydrocarbon type (e.g., oil, gas, and gas condensate), expected volumes to be discovered in a reservoir, cumulative volumes for all reservoirs, and volumes of each hydrocarbon type. In such embodiments, the prospect portfolio information may be obtained in a tabulated format having each item of data. In some embodiments, the prospect portfolio information may be obtained from a database of prospect portfolios for a given reservoir.

Each prospect scenario may be sorted by volume from large to small (block 114). That is, that data in each prospect scenario may be ranked by volume. By way of example, Table 7 depicts a prospect portfolio having three prospect scenarios, each sorted by volume (in MMBOE):

TABLE 7
PROSPECT PORTFOLIO SCENARIOS
WITH SORTED VOLUMES

| Scenario 1 | Scenario 2 | Scenario 3 |
|---|---|---|
| Prospect | Prospect | Prospect |
| Volumes | Volumes | Volumes |
| 578 | 200 | 1000 |
| 300 | 80 | 650 |
| 144 | 50 | 200 |
| 62 | 28 | 98 |
| 31 | 16 | 49 |
| 16 | 8 | 25 |
| 9 | 4 | 10 |
| 4 | 2 | 6 |
| 2 | 1 | 3 |

Additionally, probability values may be assigned to each volume in each prospect scenario (block 116). In some embodiments, the probability values may be calculated according to Formula (1) described infra. Table 8 depicts the probabilities for the prospect scenarios of Table 8:

TABLE 8
PROSPECT PORTFOLIO SCENARIOS WITH
SORTED VOLUMES AND PROBABILITIES

| Scenario 1 | Scenario 2 | Scenario 3 | |
|---|---|---|---|
| Prospect | Prospect | Prospect | Probability of |
| Volumes | Volumes | Volumes | Each Volume |
| 578 | 200 | 1000 | 0.9 |
| 300 | 80 | 650 | 0.8 |
| 144 | 50 | 200 | 0.7 |
| 62 | 28 | 98 | 0.6 |
| 31 | 16 | 49 | 0.5 |
| 16 | 8 | 25 | 0.4 |
| 9 | 4 | 10 | 0.3 |
| 4 | 2 | 6 | 0.2 |
| 2 | 1 | 3 | 0.1 |

Next, the prospect scenario volumes may be plotted with the discovered volumes in lognormal scale vs. probability (block 118). FIG. 3 depicts a plot 300 of volumes (on the x-axis) in lognormal scale vs. probability (on the y-axis) in accordance with an embodiment of the disclosure. By way of example, FIG. 3 depicts the volumes of the prospect scenarios from Table 6 and each quintile from Table 5. FIG. 3 includes the lines for each quintile as also illustrated in FIG. 2: line 202 corresponding to the First Quintile of Table 5, line 204 corresponding to the Second Quintile of Table 5, line 206 corresponding to the Third Quintile of Table 5, line 208 corresponding to the Fourth Quintile of Table 5, and line 210 corresponding to the Fifth Quintile of Table 5.

In some embodiments, a line for each prospect scenario may be fit to the respective volumes of the scenario to further illustrate each prospect scenario. As shown in FIG. 3, line 302 corresponds to prospect scenario 1, line 304 corresponds to prospect scenario 2, and line 306 corresponds to prospect scenario 3.

Next, the plotted prospect scenarios (i.e., prospect volumes) may be compared with a selected quintile of the discovered volumes and classified based on the comparison (block 120). For example, in some embodiments a geologic basin may be assumed to have larger volumes discovered first. In such embodiments, the fifth quintile may be the selected quintile as it includes the volumes discovered later in time and thus may include values that are more representative of future discovered volumes. In other embodiments, a different quintile may be selected if it is more representative of future discovered volumes.

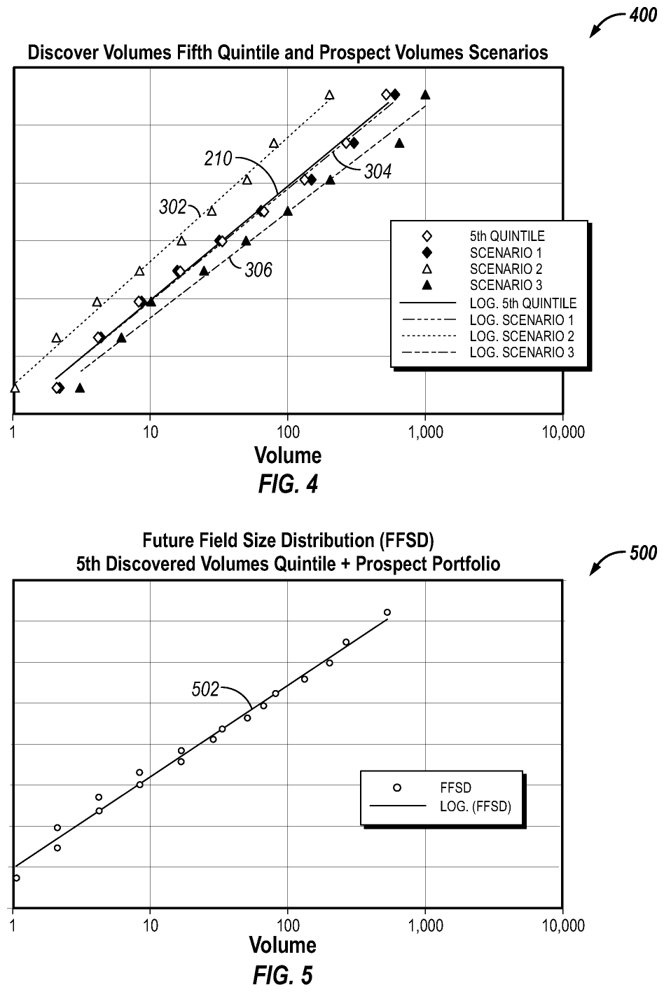

By way of example, FIG. 4 depicts a plot 400 of volumes (on the x-axis) in lognormal scale vs. probability (on the y-axis) comparing the example prospect scenarios with the fifth discovered volume quintile from Table 5 in accordance with an embodiment of the disclosure. FIG. 4 depicts the line from FIG. 2 corresponding to the fifth discovered volume quintile and the lines from FIG. 3 corresponding to the prospect volumes: line 210 corresponding to the Fifth Quintile of Table 5, line 304 corresponding to prospect scenario 1, line 302 corresponding to prospect scenario 2, and line 306 corresponding to prospect scenario 3.

Based on a comparison with the selected discovered volume quintile, the prospect scenarios may be classified as realistic, pessimistic, or optimistic, based on an assumption that relatively smaller volumes are likely to be discovered in the future. A prospect scenario line that is to the left of the discovered volume quintile line may be classified as pessimistic. A prospect scenario line that is to the right of the discovered volume quintile line may be classified as optimistic. A prospect scenario line that overlays the discovered volume quintile line may be classified as realistic. As used herein, a prospect scenario line may be considered to “overlay” a discovered volume quintile line if the prospect volumes are within 20% of the discovered volumes (e.g., the prospect volumes are no more than 20% greater or smaller than the discovered volume). If the prospect volumes are greater than 20% of the selected discovered volumes (e.g., to the right of the discovered volume quintile line 210), the prospect volumes may be considered to be “optimistic.” If the prospect volumes are 20% smaller or more of the selected discovered volumes (e.g., to the left of the discovered volume quintile line 210), the prospect volumes may be considered to be “pessimistic.”

By way of example, as shown in FIG. 4, the first prospect scenario line 304 overlays the discovered volume quintile line 210; thus, the first prospect scenario 304 may be classified as realistic. As also shown in FIG. 4, the second prospect scenario line 302 is located to the left of the discovered volume quintile line 210; accordingly, the second prospect scenario line 302 may be classified as pessimistic. Finally, the third prospect scenario line 306 is located to the right of the discovered volume quintile line 212; thus, the second prospect scenario line 306 may be classified as optimistic. Table 9 provides a summary of the comparison of the example prospect volumes with the discovered volume quintile line shown in FIG. 4:

TABLE 9
COMPARISON OF PROSPECT VOLUMES WITH
DISCOVERED VOLUMES QUINTILE

| | |
|---|---|
| Prospects Volumes with | Realistic (Prospects |
| 20% of Fifth Quintile | Scenario 1 - line 304) |
| Prospects Volumes to the | Pessimistic(Prospects |
| left of Fifth Quintile | Scenario 2 - line 302) |
| Prospects Volumes to the | Optimistic(Prospects |
| right of Fifth Quintile | Scenario 3 - line 306) |

Next, a prospect scenario may be selected and combined with the selected discovered volume quintile to determine a future field size distribution (FFSD) (block 122). In some embodiments, the prospect volumes of the prospect scenario may be merged with the discovered volumes of the selected discovered volume quintile to create a single list of merged volumes. The merged volumes may be sorted from largest to smallest. Probability values may be assigned to each of the merged volumes using the Formula 1 discussed infra. The merged volumes and probability values may be plotted to depict the determined future field size distribution (FFSD). By way of example, Table 10 provides the merged volumes used to determine a future field size distribution (FFSD) based on the example data from Tables 1-9:

TABLE 10
FFSD VOLUMES AND PROBABILITIES

| FFSD Volume | Probability |
|---|---|
| 578 | 0.95 |
| 525 | 0.89 |
| 300 | 0.84 |
| 263 | 0.79 |
| 144 | 0.74 |
| 131 | 0.68 |
| 66 | 0.63 |
| 62 | 0.58 |
| 33 | 0.53 |
| 31 | 0.47 |
| 16 | 0.42 |
| 16 | 0.37 |
| 9 | 0.32 |
| 8 | 0.26 |
| 4 | 0.21 |
| 4 | 0.16 |
| 2 | 0.11 |
| 2 | 0.05 |

FIG. 5 depicts a plot 500 of the determined future field size distribution (FFSD) volumes in lognormal scale in accordance with an embodiment of the disclosure. FIG. 5 depicts volume (on the x-axis) vs. probably (on the y-axis). The line 502 shown in FIG. 5 is fitted to the plotted volumes to further illustrate the determined future field size distribution (FFSD).

The determined future field size distribution (FFSD) may be classified based on the classification of the selected prospect scenario. For example, if the first prospects scenario from Table 7 is selected to determine the future field size distribution (FFSD), such as shown in FIG. 5, the FFSD may be classified as realistic. In another example, if the second prospect scenario from Table 7 is selected to determine the future field size distribution (FFSD), the FFSD may be classified as pessimistic. If the third prospect scenario from Table 7 is selected to determine the future field size distribution (FFSD), the FFSD may be classified as optimistic.

After determining the future field size distribution (FFSD), undiscovered hydrocarbon resources may be assessed (block 124). Additionally, drilling targets and locations for the basin may be selected and wells may be drilled at selected locations in the geologic area of interest (block 126). For example, the future field size distribution (FFSD) may provide data for estimating future discoveries and the selection of the number of wells.

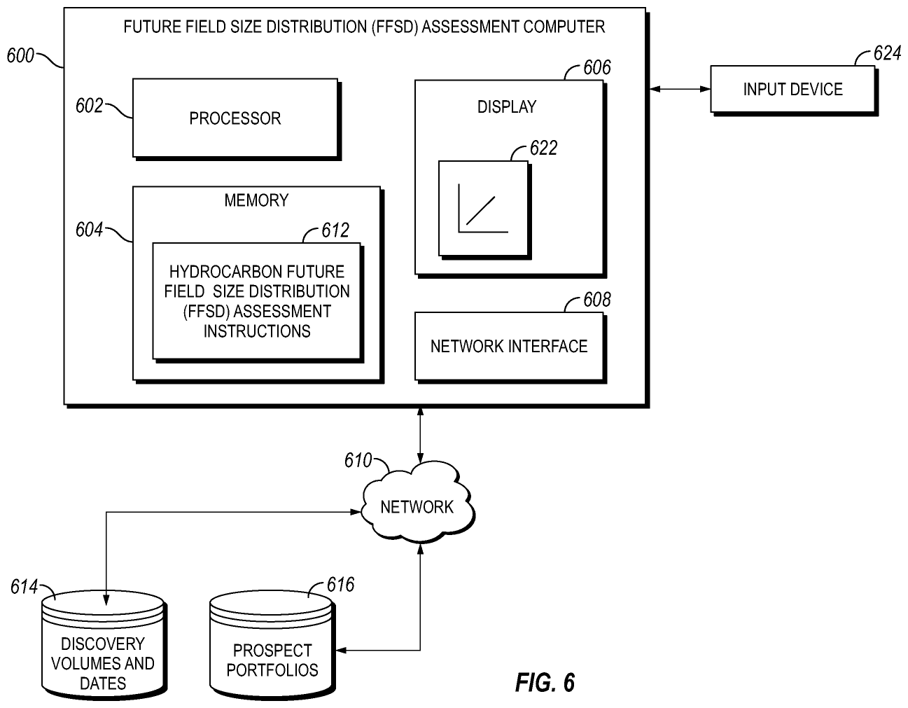

FIG. 6 depicts components of a future field size distribution (FFSD) assessment computer 600 in accordance with an embodiment of the disclosure. In some embodiments, the future field size distribution (FFSD) assessment computer 600 may be in communication with other components of a system for obtaining hydrocarbon resources data. Such other components may include, for example, logging-while-drilling (LWD) systems, measurement-while-drilling (MWD) systems, and other systems that acquire information about hydrocarbon resources. As will be appreciated, such systems may use downhole tools, downhole sensors, drilling components, and other components for acquiring information about subsurface hydrocarbon resources.

As shown in FIG. 6, the future field size distribution (FFSD) assessment computer 600 may include a processor 602, a memory 604, a display 606, and a network interface 608 that may be in communication with a network 610. It should be appreciated that the future field size distribution (FFSD) assessment computer 600 may include other components that are omitted for clarity. In some embodiments, future field size distribution (FFSD) assessment computer 600 may include or be a part of a computer cluster, cloud-computing system, a data center, a server rack or other server enclosure, a server, a virtual server, a desktop computer, a laptop computer, a tablet computer, or the like. In some embodiments, the future field size distribution (FFSD) assessment computer 600 is not a part or does not have access to additional computing resources of a computer cluster, cloud computing system, etc., and may be used on-site at a remote wellsite for example.

The processor 602 (as used the disclosure, the term “processor” encompasses microprocessors) may include one or more processors having the capability to receive and process hydrocarbon resources data, such as the data described in the disclosure.. In some embodiments, the processor 602 may include an application-specific integrated circuit (ASIC). In some embodiments, the processor 602 may include a reduced instruction set (RISC) processor. Additionally, the processor 602 may include a single-core processors and multicore processors and may include graphics processors. Multiple processors may be employed to provide for parallel or sequential execution of one or more of the techniques described in the disclosure. The processor 602 may receive instructions and data from a memory (for example, memory 604).

The memory 604 (which may include one or more tangible non-transitory computer readable storage mediums) may include volatile memory, such as random access memory (RAM), and non-volatile memory, such as ROM, flash memory, a hard drive, any other suitable optical, magnetic, or solid-state storage medium, or a combination thereof. The memory 604 may be accessible by the processor 602. The memory 604 may store executable computer code. The executable computer code may include computer program instructions for implementing one or more techniques described in the disclosure. For example, the executable computer code may include future field size distribution (FFSD) assessment instructions 612 to implement embodiments of the present disclosure. In some embodiments, the future field size distribution (FFSD) assessment instructions 612 may implement one or more elements of process 100 described above and illustrated in FIGS. 1-5.

In some embodiments, the future field size distribution (FFSD) assessment instructions 612 may receive, as input, data from various sources. Such sources may be or include databases. Such dates may include, for example, a discovery volumes and dates 614, and prospect portfolios 616, for a basin of interest. The data sources may each or collectively be located on or be a part of a computer cluster, cloud-computing system, a data center, a server, a virtual server, a desktop computer, or other computing system. In such embodiments, future field size distribution (FFSD) assessment computer 600 may access the data sources via the network 610. In some embodiments, the data may be manually input to the future field size distribution (FFSD) computer.

As described herein, the future field size distribution (FFSD) assessment instructions 612 may produce, as output a plot 622 of a future field size distribution (FFSD). The plot 622 may be stored in the memory 604 and, as shown in FIG. 6, may be displayed on the display 606, such as in a graphical user interface.

The display 606 may include a cathode ray tube (CRT) display, liquid crystal display (LCD), an organic light emitting diode (OLED) display, or other suitable display. The display 606 may display a user interface (for example, a graphical user interface) that may display information received from the future field size distribution (FFSD) assessment computer 600. In accordance with some embodiments, the display 606 may be a touch screen and may include or be provided with touch sensitive elements through which a user may interact with the user interface. In some embodiments, the display 606 may display the integrated map 622 in accordance with the techniques described herein. For example, an exploration engineer may view the integrated map 622 on the display 606.

The network interface 608 may provide for communication between the future field size distribution (FFSD) assessment computer 600 and other devices and systems via the network 610. The network interface 608 may include a wired network interface card (NIC), a wireless (e.g., radio frequency) network interface card, or combination thereof. The network interface 608 may include circuitry for receiving and sending signals to and from communications networks, such as an antenna system, an RF transceiver, an amplifier, a tuner, an oscillator, a digital signal processor, and so forth. The network interface 608 may communicate with networks, such as the Internet, an intranet, a wide area network (WAN), a local area network (LAN), a metropolitan area network (MAN) or other networks. Communication over networks may use suitable standards, protocols, and technologies, such as Ethernet Bluetooth, Wireless Fidelity (Wi-Fi) (e.g., IEEE 802.11 standards), and other standards, protocols, and technologies. In some embodiments, for example, geospatial maps may be received over the network 610 via the network interface 608. In some embodiments, for example, the integrated map 622 may be provided to other devices over the network 610 via the network interface 608.

In some embodiments, future field size distribution (FFSD) assessment instructions 612 may be coupled to an input device 624 (for example, one or more input devices). The input devices 624 may include, for example, a keyboard, a mouse, a microphone, or other input devices. In some embodiments, the input device 624 may enable interaction with a user interface (for example, a graphical user interface) displayed on the display 606. For example, in some embodiments, the input devices 624 may enable the input of data such as discovery volumes and dates 614, prospect portfolios 616, or other data.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described herein. It is to be understood that the forms shown and described herein are to be taken as examples of embodiments. Elements and materials may be substituted for those illustrated and described herein, parts and processes may be reversed or omitted, and certain features may be utilized independently, all as would be apparent to one skilled in the art after having the benefit of this description. Changes may be made in the elements described herein without departing from the spirit and scope of the disclosure as described in the following claims. Headings used herein are for organizational purposes only and are not meant to be used to limit the scope of the description.

What is claimed is:

1. A method for determining a future field size distribution of a geologic area of interest, the method comprising:
obtaining a plurality of discovered volumes associated with the geologic area of interest, the plurality of discovered volumes associated with a respective plurality of dates;
sorting the plurality of discovered volumes by the respective plurality of dates;
dividing the sorted plurality of discovered volumes into quintiles, where each quintile includes a sorted subset of the plurality of discovered volumes, wherein each quintile is sorted by a size of the respective subset of the plurality of discovered volumes;
assigning a probability to each discovered volume of the respective subset of the plurality of discovered volumes of each quintile;
obtaining a plurality of prospect scenarios associated with the geologic area of interest, the plurality of prospect scenarios associated with a sorted respective plurality of prospect volumes, wherein each of the plurality of prospect scenarios is sorted by a size of the respective plurality of prospect volumes;
assigning a probability to each of the prospect volume of the sorted respectively plurality of prospect volumes of each of the plurality of prospect scenarios;
plotting, on a lognormal scale versus probability, the sorted subset of the plurality of discovered volumes of a selected quintile and the sorted respective plurality of prospect volumes for each of the plurality of prospect scenarios;
classifying the plurality of prospect scenarios into a first class, a second class, or a third class based on a comparison with the sorted subset of the plurality of discovered volumes; and
selecting, based on the classification, a prospect scenario of the plurality of prospect scenarios;
determining the future field size distribution (FFSD) for the geologic area of interest by combining the sorted respective plurality of prospect volumes of the selected prospect scenario with the sorted subset of the plurality of discovered volumes of the selected quintile.

2. The method of claim 1, comprising classifying the determined future field size distribution (FFSD) based on the classification of the selected prospect scenario.

3. The method of claim 1, wherein determining the future field size distribution (FFSD) for the geologic area of interest comprises determining the future field size distribution (FFSD) for an undiscovered hydrocarbon resource assessment.

4. The method of claim 1, comprising selecting a drilling target or location in the area of interest based on the determined future field size distribution (FFSD).

5. The method of claim 1, comprising drilling a well at the selected drilling location in the area of interest.

6. The method of claim 1, classifying the plurality of prospect scenarios into a first class, a second class, or a third class based on a comparison with the graphed subset of the plurality of discovered volumes comprises classifying one of plurality of prospect scenarios into the first class if the respective plurality of prospect volumes is less than or equal to 20% of the graphed subset of the plurality of discovered volumes.

7. The method of claim 1, wherein assigning a probability to each discovered volume of each quintile comprises:
calculating a probability of the first discovered volume of a quintile as (100/n+1)/100, where n is the number of volumes in the quintile; and
calculating a probability of each additional discovered volume of the quintile as i*(100/n+1)/100, where i is the number of the additional discovered volume.

8. The method of claim 1, wherein determining the future field size distribution (FFSD) for the geologic area of interest by combining the selected prospect scenario with the subset of the plurality of discovered volumes of the selected quintile comprises:
combining the sorted respective plurality of prospect volumes of the selected prospect scenario with the sorted subset of the plurality of discovered volumes of the selected quintile to create a plurality of merged volumes;
sorting the plurality of merged volumes from largest to smallest;
assigning a probability to each volume of the plurality of merged volumes; and
plotting, in lognormal values, the sorted plurality of merged volumes versus assigned probability.

9. The method of claim 8, wherein assigning a probability to each discovered volume of each quintile comprises:
calculating a probability of the first discovered volume of a quintile as (100/n+1)/100, where n is the number of volumes in the group; and
calculating a probability of each additional discovered volume of the quintile as i*(100/n+1)/100, where i is the number of the additional discovered volume.

10. A non-transitory computer-readable storage medium having executable code stored thereon for hydrocarbon resource exploration assessment, the executable code comprising a set of instructions that causes a processor to perform operations comprising:
obtaining a plurality of discovered volumes associated with the geologic area of interest, the plurality of discovered volumes associated with a respective plurality of dates;
sorting the plurality of discovered volumes by the respective plurality of dates;
dividing the sorted plurality of discovered volumes into quintiles, where each quintile includes a sorted subset of the plurality of discovered volumes, wherein each quintile is sorted by a size of the respective subset of the plurality of discovered volumes;
assigning a probability to each discovered volume of the respective subset of the plurality of discovered volumes of each quintile;
obtaining a plurality of prospect scenarios associated with the geologic area of interest, the plurality of prospect scenarios associated with a sorted respective plurality of prospect volumes, wherein each of the plurality of prospect scenarios is sorted by a size of the respective plurality of prospect volumes;
assigning a probability to each of the prospect volume of the sorted respectively plurality of prospect volumes of each of the plurality of prospect scenarios;
plotting, on a lognormal scale versus probability, the sorted subset of the plurality of discovered volumes of a selected quintile and the sorted respective plurality of prospect volumes for each of the plurality of prospect scenarios;
classifying the plurality of prospect scenarios into a first class, a second class, or a third class based on a comparison with the sorted subset of the plurality of discovered volumes; and
selecting, based on the classification, a prospect scenario of the plurality of prospect scenarios;
determining the future field size distribution (FFSD) for the geologic area of interest by combining the sorted respective plurality of prospect volumes of the selected prospect scenario with the sorted subset of the plurality of discovered volumes of the selected quintile.

11. The non-transitory computer-readable storage medium of claim 10, comprising classifying the determined future field size distribution (FFSD) based on the classification of the selected prospect scenario.

12. The non-transitory computer-readable storage medium of claim 10, comprising selecting a drilling target or location in the area of interest based on the determined future field size distribution (FFSD).

13. The non-transitory computer-readable storage medium of claim 10, classifying the plurality of prospect scenarios into a first class, a second class, or a third class based on a comparison with the graphed subset of the plurality of discovered volumes comprises classifying one of plurality of prospect scenarios into the first class if the respective plurality of prospect volumes is less than or equal to 20% of the graphed subset of the plurality of discovered volumes.

14. The non-transitory computer-readable storage medium of claim 10, wherein assigning a probability to each discovered volume of each quintile comprises:
calculating a probability of the first discovered volume of a quintile as (100/n+1)/100, where n is the number of volumes in the quintile; and
calculating a probability of each additional discovered volume of the quintile as i*(100/n+1)/100, where i is the number of the additional discovered volume.

15. The non-transitory computer-readable storage medium of claim 10, wherein determining the future field size distribution (FFSD) for the geologic area of interest by combining the selected prospect scenario with the subset of the plurality of discovered volumes of the selected quintile comprises:
combining the sorted respective plurality of prospect volumes of the selected prospect scenario with the sorted subset of the plurality of discovered volumes of the selected quintile to create a plurality of merged volumes;
sorting the plurality of merged volumes from largest to smallest;
assigning a probability to each volume of the plurality of merged volumes; and
plotting, in lognormal values, the sorted plurality of merged volumes versus assigned probability.

16. A system for hydrocarbon resource exploration assessment, comprising:
a processor;
a non-transitory computer-readable storage memory accessible by the processor and having executable code stored thereon, the executable code comprising a set of instructions that causes the processor to perform operations comprising:
obtaining a plurality of discovered volumes associated with the geologic area of interest, the plurality of discovered volumes associated with a respective plurality of dates;
sorting the plurality of discovered volumes by the respective plurality of dates;
dividing the sorted plurality of discovered volumes into quintiles, where each quintile includes a sorted subset of the plurality of discovered volumes, wherein each quintile is sorted by a size of the respective subset of the plurality of discovered volumes;
assigning a probability to each discovered volume of the respective subset of the plurality of discovered volumes of each quintile;
obtaining a plurality of prospect scenarios associated with the geologic area of interest, the plurality of prospect scenarios associated with a sorted respective plurality of prospect volumes, wherein each of the plurality of prospect scenarios is sorted by a size of the respective plurality of prospect volumes;
assigning a probability to each of the prospect volume of the sorted respectively plurality of prospect volumes of each of the plurality of prospect scenarios;
plotting, on a lognormal scale versus probability, the sorted subset of the plurality of discovered volumes of a selected quintile and the sorted respective plurality of prospect volumes for each of the plurality of prospect scenarios;
classifying the plurality of prospect scenarios into a first class, a second class, or a third class based on a comparison with the sorted subset of the plurality of discovered volumes; and
selecting, based on the classification, a prospect scenario of the plurality of prospect scenarios;
determining the future field size distribution (FFSD) for the geologic area of interest by combining the sorted respective plurality of prospect volumes of the selected prospect scenario with the sorted subset of the plurality of discovered volumes of the selected quintile.

17. The system of claim 16, comprising classifying the determined future field size distribution (FFSD) based on the classification of the selected prospect scenario.

18. The system of claim 16, comprising selecting a drilling target or location in the area of interest based on the determined future field size distribution (FFSD).

19. The system of claim 16, classifying the plurality of prospect scenarios into a first class, a second class, or a third class based on a comparison with the graphed subset of the plurality of discovered volumes comprises classifying one of plurality of prospect scenarios into the first class if the respective plurality of prospect volumes is less than or equal to 20% of the graphed subset of the plurality of discovered volumes.

20. The system of claim 16, wherein assigning a probability to each discovered volume of each quintile comprises:
calculating a probability of the first discovered volume of a quintile as (100/n+1)/100, where n is the number of volumes in the quintile; and
calculating a probability of each additional discovered volume of the quintile as i*(100/n+1)/100, where i is the number of the additional discovered volume.

21. The system of claim 16, wherein determining the future field size distribution (FFSD) for the geologic area of interest by combining the selected prospect scenario with the subset of the plurality of discovered volumes of the selected quintile comprises:
combining the sorted respective plurality of prospect volumes of the selected prospect scenario with the sorted subset of the plurality of discovered volumes of the selected quintile to create a plurality of merged volumes;
sorting the plurality of merged volumes from largest to smallest;
assigning a probability to each volume of the plurality of merged volumes; and
plotting, in lognormal values, the sorted plurality of merged volumes versus assigned probability.
